(19) United States
(12) Patent Application Publication
(10) Pub. No.: US 2023/0104459 A1
(43) Pub. Date: Apr. 6, 2023

(54) MINIMIZING ALGORITHMIC BIAS IN MACHINE LEARNING MODELS

(71) Applicants: AT&T Intellectual Property I, L.P., Atlanta, GA (US); AT&T Mobility II LLC, Atlanta, GA (US)

(72) Inventors: Changchuan Yin, Hoffman Estates, IL (US); Cheryl Brooks, Maplewood, NJ (US); Hemamalini Kosaraju, Wildwood, MO (US); Sachin Lohe, Allen, TX (US)

(21) Appl. No.: 17/493,712

(22) Filed: Oct. 4, 2021

(51) Int. Cl. G06N 3/04

(52) U.S. Cl. CPC G06N 3/0454

(57) ABSTRACT

A method for minimizing algorithmic bias in machine learning models includes generating, using a first machine learning model, a first output representing a prediction, where the first output is generated in response to a first plurality of inputs including sensitive features and non-sensitive features, generating, using a second machine learning model, a second output that minimizes an influence of an algorithmic bias in the first output, where the second output is generated in response to a second plurality of inputs including the non-sensitive features and the first output, and generating a recommendation related to the prediction based on the second output.

The present disclosure relates generally to machine learning, and relates more particularly to devices, non-transitory computer-readable media, and methods for deploying a neural network architecture in order to minimize the algorithmic bias present in machine learning models.

### BACKGROUND

Machine learning is a subset of artificial intelligence encompassing computer algorithms whose outputs improve with experience. A set of sample or “training” data may be provided to a machine learning algorithm, which may learn patterns in the training data that can be used to build a model that is capable of making predictions or decisions (outputs) based on a set of inputs (e.g., new data). Machine learning models may be used to automate the performance of repeated tasks, to recognize natural languages and texts, to provide navigation for unmanned vehicles, and to perform other tasks or actions.

### SUMMARY

The present disclosure broadly discloses methods, computer-readable media, and systems for minimizing algorithmic bias in machine learning models. In one example, a method performed by a processing system including at least one processor includes generating, using a first machine learning model, a first output representing a prediction, where the first output is generated in response to a first plurality of inputs including sensitive features and non-sensitive features, generating, using a second machine learning model, a second output that minimizes an influence of an algorithmic bias in the first output, where the second output is generated in response to a second plurality of inputs including the non-sensitive features and the first output, and generating a recommendation related to the prediction based on the second output.

In another example, a non-transitory computer-readable medium may store instructions which, when executed by a processing system including at least one processor, cause the processing system to perform operations. The operations may include generating, using a first machine learning model, a first output representing a prediction, where the first output is generated in response to a first plurality of inputs including sensitive features and non-sensitive features, generating, using a second machine learning model, a second output that minimizes an influence of an algorithmic bias in the first output, where the second output is generated in response to a second plurality of inputs including the non-sensitive features and the first output, and generating a recommendation related to the prediction based on the second output.

In another example, a device may include a processing system including at least one processor and a non-transitory computer-readable medium storing instructions which, when executed by the processing system, cause the processing system to perform operations. The operations may include generating, using a first machine learning model, a first output representing a prediction, where the first output is generated in response to a first plurality of inputs including sensitive features and non-sensitive features, generating, using a second machine learning model, a second output that minimizes an influence of an algorithmic bias in the first output, where the second output is generated in response to a second plurality of inputs including the non-sensitive features and the first output, and generating a recommendation related to the prediction based on the second output.

### BRIEF DESCRIPTION OF THE DRAWINGS

The teachings of the present disclosure can be readily understood by considering the following detailed description in conjunction with the accompanying drawings, in which:

FIG. 1 illustrates an example system in which examples of the present disclosure for minimizing algorithmic bias in machine learning models may operate;

FIG. 2 illustrates one example of a machine learning model that may be employed by the application server of FIG. 1;

FIG. 3 illustrates a flowchart of an example method for minimizing algorithmic bias in machine learning models, in accordance with the present disclosure; and

FIG. 4 illustrates an example of a computing device, or computing system, specifically programmed to perform the steps, functions, blocks, and/or operations described herein.

To facilitate understanding, similar reference numerals have been used, where possible, to designate elements that are common to the figures.

### DETAILED DESCRIPTION

The present disclosure broadly discloses methods, computer-readable media, and systems for minimizing algorithmic bias in machine learning models. As discussed above, machine learning algorithms are trained using a set of training data to make predictions or decisions (outputs) based on a set of inputs (e.g., new data). Machine learning has proven invaluable in facilitating business decisions; however, algorithmic biases represent an ethical threat to the use of machine learning in decision making.

An algorithmic bias in this context refers to a systematic and repeatable error in a computer application that creates unfair outcomes (e.g., outcomes that treat certain classes preferentially at the expense of other classes). Conversely, an algorithm is considered to be fair (or unbiased) when the algorithm's results are independent of given variables, and in particular independent of variables that may be considered sensitive or associated with classes that have been historically discriminated against (e.g., classes related to race, gender, age, or the like) and that should not correlate with the results. Ideally, neural network models should produce non-discriminatory predictions by constraining bias with respect to predicted outcomes for protected classes or identities (which may be defined by race, gender, age, or the like).

Current industry-standard practices for enforcing algorithmic fairness in machine learning tend to only detect bias with respect to sensitive attributes whose values are binary (e.g., male/female), whereas many machine learning problems may involve sensitive attributes whose values may be non-binary (e.g., may fall across a spectrum of two or more continuous values). As an example, a machine learning algorithm for determining where to deploy infrastructure for a national fifth generation (5G) network may consider attributes like population censuses and income, whose values may fall in multiple (i.e., more than two) locations along a continuous numerical scale.

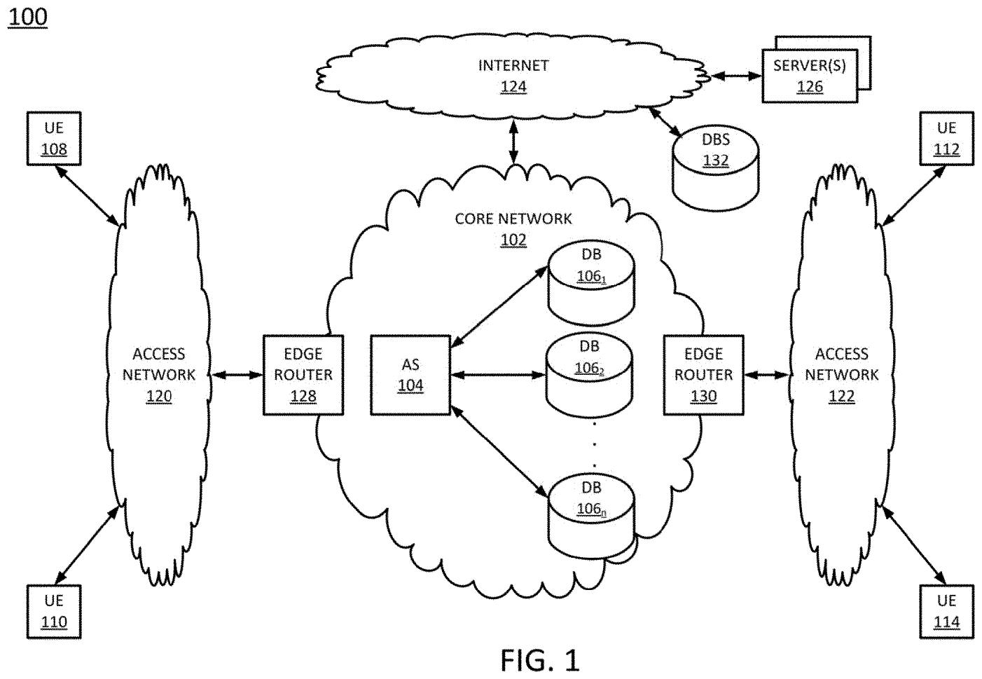

Examples of the present disclosure provide a neural network architecture that mitigates algorithmic bias, and in particular mitigates bias associated with attributes or classes whose values may be non-binary. In one example, the neural network architecture comprises an application neural network and a bias control neural network arranged in a feedback loop. The application neural network may be trained to build a model for making business decisions, while the bias control neural network may be trained to mitigate the algorithmic bias in the application neural network. In one example, the bias control neural network employs adversarial learning to remove bias according to sensitive numerical attributes whose values may be non-binary or may fall across a spectrum of two or more continuous values. An advantage of working with raw continuous variable values (versus binning or discretizing the values) is that the bias in a machine learning model can be removed without concern that the results are dependent upon the choice of binning structure or cut point. These and other aspects of the present disclosure are discussed in greater detail below in connection with the examples of FIGS. 1-4.

To further aid in understanding the present disclosure, FIG. 1 illustrates an example system 100 in which examples of the present disclosure for minimizing algorithmic bias in machine learning models may operate. The system 100 may include any one or more types of communication networks, such as a traditional circuit switched network (e.g., a public switched telephone network (PSTN)) or a packet network such as an Internet Protocol (IP) network (e.g., an IP Multimedia Subsystem (IMS) network), an asynchronous transfer mode (ATM) network, a wired network, a wireless network, and/or a cellular network (e.g., 2G-5G, a long term evolution (LTE) network, and the like) related to the current disclosure. It should be noted that an IP network is broadly defined as a network that uses Internet Protocol to exchange data packets. Additional example IP networks include Voice over IP (VoIP) networks, Service over IP (SoIP) networks, the World Wide Web, and the like.

In one example, the system 100 may comprise a core network 102. The core network 102 may be in communication with one or more access networks 120 and 122, and with the Internet 124. In one example, the core network 102 may functionally comprise a fixed mobile convergence (FMC) network, e.g., an IP Multimedia Subsystem (IMS) network. In addition, the core network 102 may functionally comprise a telephony network, e.g., an Internet Protocol/Multi-Protocol Label Switching (IP/MPLS) backbone network utilizing Session Initiation Protocol (SIP) for circuit-switched and Voice over Internet Protocol (VoIP) telephony services. In one example, the core network 102 may include at least one application server (AS) 104, a plurality of databases (DBs) 106₁-106ₙ (hereinafter individually referred to as a “database 106” or collectively referred to as “databases 106”), and a plurality of edge routers 128-130. For ease of illustration, various additional elements of the core network 102 are omitted from FIG. 1.

In one example, the access networks 120 and 122 may comprise Digital Subscriber Line (DSL) networks, public switched telephone network (PSTN) access networks, broadband cable access networks, Local Area Networks (LANs), wireless access networks (e.g., an IEEE 802.11/Wi-Fi network and the like), cellular access networks, 3rd party networks, and the like. For example, the operator of the core network 102 may provide a cable television service, an IPTV service, or any other types of telecommunication services to subscribers via access networks 120 and 122. In one example, the access networks 120 and 122 may comprise different types of access networks, may comprise the same type of access network, or some access networks may be the same type of access network and other may be different types of access networks. In one example, the core network 102 may be operated by a telecommunication network service provider (e.g., an Internet service provider, or a service provider who provides Internet services in addition to other telecommunication services). The core network 102 and the access networks 120 and 122 may be operated by different service providers, the same service provider or a combination thereof, or the access networks 120 and/or 122 may be operated by entities having core businesses that are not related to telecommunications services, e.g., corporate, governmental, or educational institution LANs, and the like.

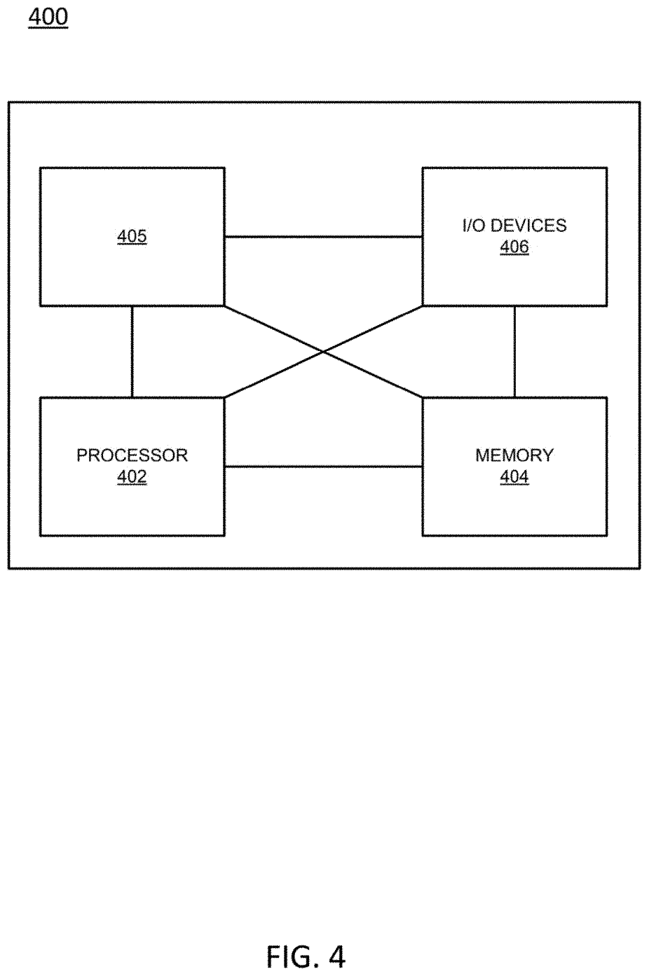

In one example, the access network 120 may be in communication with one or more user endpoint devices 108 and 110. Similarly, the access network 122 may be in communication with one or more user endpoint devices 112 and 114. The access networks 120 and 122 may transmit and receive communications between the user endpoint devices 108, 110, 112, and 114, between the user endpoint devices 108, 110, 112, and 114, the server(s) 126, the AS 104, other components of the core network 102, devices reachable via the Internet in general, and so forth. In one example, each of the user endpoint devices 108, 110, 112, and 114 may comprise any single device or combination of devices that may comprise a user endpoint device, such as computing system 400 depicted in FIG. 4, and may be configured as described below. For example, the user endpoint devices 108, 110, 112, and 114 may each comprise a mobile device, a cellular smart phone, a gaming console, a set top box, a laptop computer, a tablet computer, a desktop computer, an application server, a bank or cluster of such devices, and the like. In one example, any one of the user endpoint devices 108, 110, 112, and 114 may be operable by a human user to provide guidance and feedback to the AS 104, which may be configured to build a machine learning model in a manner that minimizes the algorithmic bias of the machine learning model, as discussed in greater detail below.

In one example, one or more servers 126 and one or more databases 132 may be accessible to user endpoint devices 108, 110, 112, and 114 via Internet 124 in general. The server(s) 126 and DBs 132 may be associated with Internet content providers, e.g., entities that provide content (e.g., news, blogs, videos, music, files, products, services, or the like) in the form of websites (e.g., social media sites, general reference sites, online encyclopedias, or the like) to users over the Internet 124. Thus, some of the servers 126 and DBs 132 may comprise content servers, e.g., servers that store content such as images, text, video, and the like which may be served to web browser applications executing on the user endpoint devices 108, 110, 112, and 114 and/or to AS 104 in the form of websites.

In accordance with the present disclosure, the AS 104 may be configured to provide one or more operations or functions in connection with examples of the present disclosure for minimizing algorithmic bias in machine learning models, as described herein. The AS 104 may comprise one or more physical devices, e.g., one or more computing systems or servers, such as computing system 400 depicted in FIG. 4, and may be configured as described below. It should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIG. 4 and discussed below) or multiple computing devices collectively configured to perform various steps, functions, and/or operations in accordance with the present disclosure.

In one example, the AS 104 may be configured to generate predictions by employing machine learning models that are built to minimize algorithmic bias. In particular, the AS 104 may be configured to generate predictions by employing a machine learning model that comprises two neural networks arranged in a feedback loop.

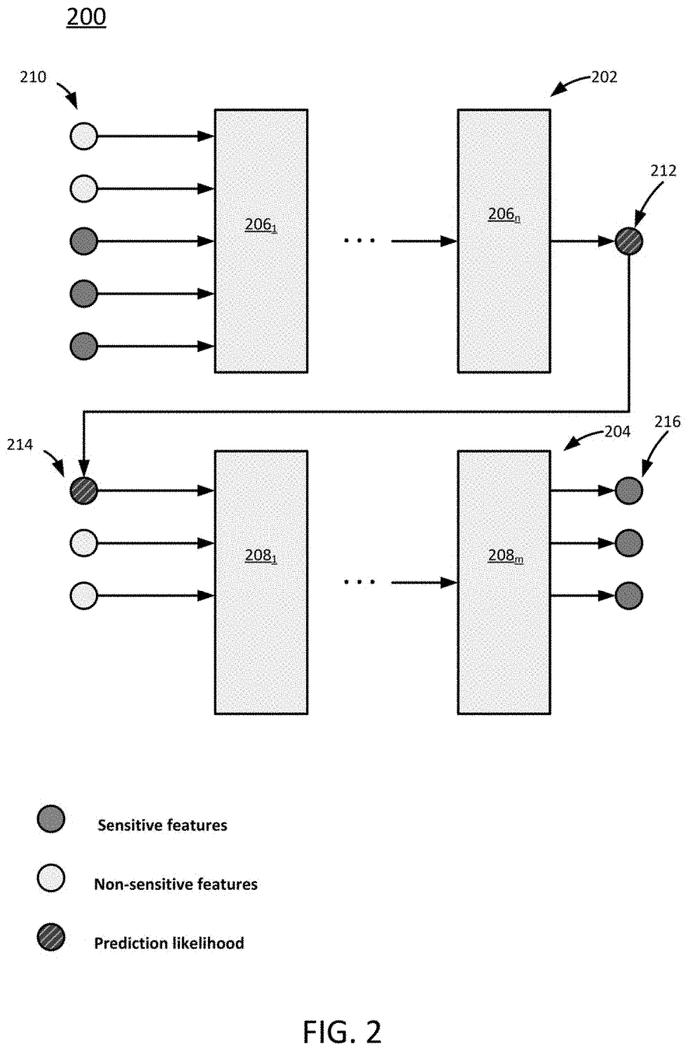

FIG. 2, for instance, illustrates one example of a machine learning model 200 that may be employed by the AS 104 of FIG. 1. As illustrated, the machine learning model 200 generally comprises an application (e.g., a first) machine learning model 202 and a controller (e.g., a second) machine learning model 204. In one example, the application machine learning model 202 is trained to produce a business decision (e.g., a prediction) as an output, while the controller machine learning model 204 is trained to mitigate algorithmic bias in the output of the application machine learning model 202.

In one example, both the application machine learning model 202 and the controller machine learning model 204 comprise neural networks (although in other examples, one or both of the application machine learning model 202 and the controller machine learning model 204 may comprise another type of machine learning classifier). To this end, the application machine learning model 202 may comprise a first input layer 210, a first plurality of hidden layers 206₁-206ₙ (hereinafter individually referred to as a “hidden layer 206” or collectively referred to as “hidden layers 206”), and a first output layer 212. The controller machine learning model 204 may comprise a second input layer 214, a second plurality of hidden layers 208₁-208ₘ (hereinafter individually referred to as a “hidden layer 208” or collectively referred to as “hidden layers 208”), and a second output layer 216. Both the application machine learning model 202 and the controller machine learning model 204 may comprise any number of neural nodes and any number of hidden layers. In other words, neither the application machine learning model 202 nor the controller machine learning model 204 is constrained to any specific neural network configuration in this example.

The first input layer 210 may comprise a plurality of inputs to the application machine learning model 202. The plurality of inputs to the application machine learning model 202 may comprise both sensitive features (e.g., such as gender (including sexual orientation and identity), race, color, nationality, religion, age, disability, occupation, income level, education level such as degree or area of educational background, interests, or other characteristics deemed to be sensitive in a particular context) and non-sensitive features (e.g., such as climate, topography, equipment characteristics, or technical requirements) as illustrated. The first output layer 212 may comprise an output (e.g., a prediction likelihood, a business decision, etc.) of the application machine learning model 202.

As illustrated, the output of the application machine learning model 202 is provided as an input to the controller machine learning model 204. Thus, the second input layer 214 may comprise a plurality of inputs to the controller machine learning model 204, where the plurality of inputs to the controller machine learning model 204 may comprise the output of the application machine learning model 202. In addition, the plurality of inputs to the controller machine learning model 204 include the non-sensitive features that were provided as inputs to the application machine learning model 202; the sensitive features that were provided as inputs to the application machine learning model 202 are not provided as inputs to the controller machine learning model 204. Thus, the controller machine learning model 204 may operate to regress the expected sensitive features. The second output layer 216 may comprise a plurality of outputs (i.e., sensitive features) of the controller machine learning model 204. Thus, in one example, the controller machine learning model 204 may comprise a multi-task neural network.

In one example, the goal of the machine learning model 200 is to train the application machine learning model 202, while ensuring that the distributions (e.g., empirical cumulative distribution functions) of the regressed sensitive features in the output of the controller machine learning model 204 conform to the distributions of the sensitive features that are originally provided as inputs to the application machine learning model 202. Thus, the application machine learning model 202 generates a model with mitigated bias through the controller machine learning model 204. The application machine learning model 202 may be trained for a business application (e.g., to determine if a 5G tile should be installed in a specific demographic location). The controller machine learning model 204 may be trained to control and evaluate the algorithmic fairness in the application machine learning model 202. Thus, the application machine learning model 202 may minimize the loss function of the targets (e.g., the output) of the machine learning model 200, while the controller machine learning model 204 maximizes the loss function of the targets. It should be noted that the loss function of the application machine learning model 202 contains the losses of the targets in both the application machine learning model 202 and the controller machine learning model 204. Thus, the machine learning model 200 has a min-max mechanism for two coupled machine learning models.

Fairness (or minimization of bias) is achieved through the coupling mechanism of the application machine learning model 202 and the controller machine learning model 204. In the coupling mechanism, the loss function in the application machine learning model 202 comprises the losses of both the application machine learning model 202 and the controller machine learning model 204. Therefore, the application machine learning model 202 is bias-mitigated through the controller machine learning model 204.

Collectively, the application machine learning model 202 and the controller machine learning model 204 form a machine learning architecture that is similar to a generative adversarial network. However, the machine learning model 200 differs from conventional generative adversarial networks in a plurality of ways. First, in a typical generative adversarial network, the output of a generator neural network (which is trained to generate new examples) is provided as input to a discriminator neural network (which is trained to classify examples as either real/from the domain or fake/generated). Data is generated randomly by the generator neural network. However, in an example of the present disclosure, the application machine learning model 202 uses real (e.g., not generated or fake) data, and the controller machine learning model 204 may be used as a predictor. Thus, the application machine learning model 202 functions differently from a typical generator.

In addition, in a typical generative adversarial network, the discriminator neural network tests whether the data generated by the generator neural network is similar to the target real data. However, according to examples of the present disclosure, the controller machine learning model may produce multiple outputs (e.g., sensitive features) which mimic the original sensitive features provided as input to the application machine learning model 202.

Furthermore, in a typical generative adversarial network, the data from the generator neural network feeds the discriminator neural network. However, according to examples of the present disclosure, the data feeding the controller machine learning model 204 also contains generated features and original non-sensitive features (which were originally provided as inputs to the application machine learning model 202), with the original sensitive features (which were originally provided as inputs to the application machine learning model 202) being removed.

Moreover, in a typical generative adversarial network, the goal of the generative adversarial network is to produce fake data that is similar to real data. However, examples of the present disclosure aim to train the production model for a predictor with minimized bias, and, thus, the acceptance criteria are different. For instance, a typical generative adversarial network may check the loss of produced data and real data. But the machine learning model 200 of the present disclosure compares the distributions in sensitive features (e.g., using either entropy density or Kolmogorov-Smirnov statistics).

Referring back to FIG. 1, the AS 104 may obtain input data for the machine learning model 200 (e.g., sensitive features and non-sensitive features) from a plurality of data sources. For instance, each of the DBs 106 and 132 may operate as a data source that contains sensitive features and/or non-sensitive features. New data sources may be added at any time to the set of DBs 106 to address new and evolving fairness needs. Moreover, existing DBs may be updated at any time to include new data about sensitive features.

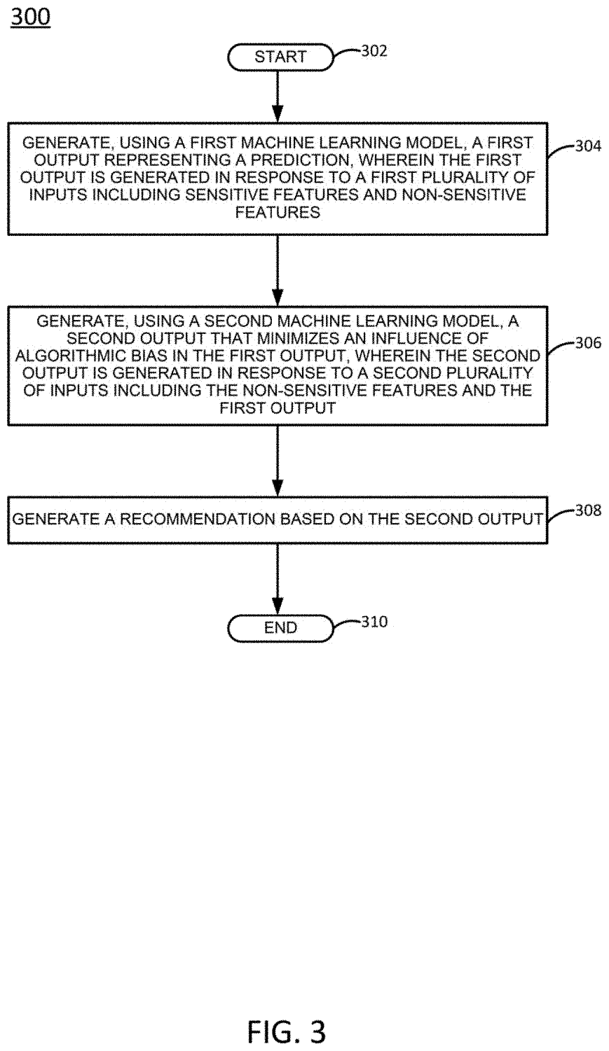

In one example, the DBs 106 may comprise physical storage devices integrated with the AS 104 (e.g., a database server or a file server), or attached or coupled to the AS 104, in accordance with the present disclosure. In one example, the AS 104 may load instructions into a memory, or one or more distributed memory units, and execute the instructions for minimizing algorithmic bias in machine learning models, as described herein. Example methods for minimizing algorithmic bias in machine learning models are described in greater detail below in connection with FIGS. 2-3.

It should be noted that the system 100 has been simplified. Thus, those skilled in the art will realize that the system 100 may be implemented in a different form than that which is illustrated in FIG. 1, or may be expanded by including additional endpoint devices, access networks, network elements, application servers, etc. without altering the scope of the present disclosure. In addition, system 100 may be altered to omit various elements, substitute elements for devices that perform the same or similar functions, combine elements that are illustrated as separate devices, and/or implement network elements as functions that are spread across several devices that operate collectively as the respective network elements.

For example, the system 100 may include other network elements (not shown) such as border elements, routers, switches, policy servers, security devices, gateways, a content distribution network (CDN) and the like. For example, portions of the core network 102, access networks 120 and 122, and/or Internet 124 may comprise a content distribution network (CDN) having ingest servers, edge servers, and the like. Similarly, although only two access networks, 120 and 122 are shown, in other examples, access networks 120 and/or 122 may each comprise a plurality of different access networks that may interface with the core network 102 independently or in a chained manner. For example, UE devices 108, 110, 112, and 114 may communicate with the core network 102 via different access networks, user endpoint devices 110 and 112 may communicate with the core network 102 via different access networks, and so forth. Thus, these and other modifications are all contemplated within the scope of the present disclosure.

FIG. 3 illustrates a flowchart of an example method 300 for minimizing algorithmic bias in machine learning models, in accordance with the present disclosure. In one example, steps, functions and/or operations of the method 300 may be performed by a device as illustrated in FIG. 1, e.g., AS 104 or any one or more components thereof. In another example, the steps, functions, or operations of method 300 may be performed by a computing device or system 400, and/or a processing system 402 as described in connection with FIG. 4 below. For instance, the computing device 400 may represent at least a portion of the AS 104 in accordance with the present disclosure. For illustrative purposes, the method 300 is described in greater detail below in connection with an example performed by a processing system in an Internet service provider network, such as processing system 402.

The method 300 begins in step 302 and proceeds to step 304. In step 304, the processing system may generate, using a first machine learning model, a first output representing a prediction, where the first output is generated in response to a first plurality of inputs including sensitive features and non-sensitive features. In one example, the first machine learning model is trained to produce a business decision (the prediction) based on the first plurality of inputs. For instance, the business decision may comprise whether a 5G tile should be installed in a specific demographic location which is described by the sensitive features and the non-sensitive features.

As discussed above, the first machine learning model may comprise an application machine learning model that is coupled, by way of a feedback loop, to a controller machine learning model. In one example, the first machine learning model comprises a neural network including a first input layer, a first plurality of hidden layers, and a first output layer (e.g., similar to application machine learning model 202 of FIG. 2).

In one example, the “sensitive” features may comprise data attributes that relate to an underrepresented entity or class (e.g., a group of people who share some characteristic that may be historically or culturally underrepresented). For instance, where the business decision comprises whether a 5G tile should be installed in a specific demographic location, the sensitive features may describe attributes of the individuals who live in and around the specific demographic location, such as e.g., gender (including sexual orientation and identity), race, color, nationality, religion, age, disability, occupation, income level, education level such as degree or area of educational background, interests, or other characteristics deemed to be sensitive. Moreover, at least one feature of the sensitive features may comprise a feature whose values are non-binary (e.g., fall along a continuous numerical scale or spectrum of two of more values). For instance, the feature may comprise a median income in a given geographic location or a percentage of the population in a given geographic location who identify with a specific ethnicity.

“Non-sensitive” features may comprise data attributes that do not relate to an underrepresented entity or class. For example, where the business decision comprises whether a 5G tile should be installed in a specific geographic location, the non-sensitive features may describe attributes of the specific geographic location which are independent of the individuals who live in and around the specific demographic location, such as average temperature, climate, topography, distance to nearest existing 5G tile, signal strength, signal impairing structures, equipment requirements, and the like. In one example, at least some of the non-sensitive features may also comprise features whose values are non-binary. However, the values of the non-sensitive features can also be categorical, binary (Boolean), numerical, multi-dimensional vectors, text, and other types of values.

In step 306, the processing system may generate, using a second machine learning model, a second output that minimizes an influence of an algorithmic bias in the first output, where the second output is generated in response to a second plurality of inputs including the non-sensitive features (which were input to the first machine learning model) and the first output (of the first machine learning model). In one example, the second machine learning model is trained to produce the sensitive features as an output based on the second plurality of inputs. In one example, the second plurality of inputs omits the sensitive features that were included in the first plurality of inputs. The second machine learning model thus regresses the sensitive features. The distributions of the sensitive features, as output by the second machine learning model, are similar to the distributions of the sensitive features as originally input to the first machine learning model. Thus, the algorithmic bias of the first machine learning model is minimized in taking the first plurality of inputs. In other words, the second machine learning model increases the likelihood that the output of the first machine learning model is fair (e.g., unbiased).

As discussed above, the second machine learning model may comprise a controller machine learning model that is coupled, by way of a feedback loop, to the first (application) machine learning model. In one example, the second machine learning model comprises a neural network including a second input layer, a second plurality of hidden layers, and a second output layer.

In step 308, the processing system may generate a recommendation related to the prediction based on the second output. For instance, as discussed above, the first output may comprise a business decision or prediction (e.g., install a 5G tile at a specific demographic location or do not install a 5G tile at a specific demographic location). The second output may indicate that any algorithmic bias which may have influenced the first output has been minimized. Thus, the processing system may assume that the first output, with the influence of the algorithmic bias minimized, constitutes a fair decision. Accordingly, the processing system may generate a recommendation to accept the first output. However, in other examples, the processing system may generate a recommendation to reject the first output, to repeat the decision making process (of steps 304-408, potentially with a greater number of and/or different types of input features), to adjust the decision making process (e.g., by retraining one or both of the first machine learning model and the second machine learning model), or the like.

The method 300 may end in step 310.

It should be noted that the method 300 may be expanded to include additional steps or may be modified to include additional operations with respect to the steps outlined above. In addition, although not specifically specified, one or more steps, functions, or operations of the method 300 may include a storing, displaying, and/or outputting step as required for a particular application. In other words, any data, records, fields, and/or intermediate results discussed in the method can be stored, displayed, and/or outputted either on the device executing the method or to another device, as required for a particular application. Furthermore, steps, blocks, functions or operations in FIG. 3 that recite a determining operation or involve a decision do not necessarily require that both branches of the determining operation be practiced. In other words, one of the branches of the determining operation can be deemed as an optional step. Furthermore, steps, blocks, functions or operations of the above described method can be combined, separated, and/or performed in a different order from that described above, without departing from the examples of the present disclosure.

Thus, in some examples, the method 300 may remove bias according to sensitive numerical attributes whose values may be non-binary. As an example, a telecommunications service provider may be evaluating several specific demographic locations as possible locations for a new 5G tile. A machine learning model (similar to the machine learning model 200 of FIG. 2) may be deployed that considers sensitive attributes of the specific demographic locations including numerical population and income (e.g., mean or median), as well as non-sensitive attributes (e.g., including distance to nearest existing 5G tile and/or other technical attributes). Bias in the application machine learning model can be detected and mitigated using a controller machine learning model that takes the non-sensitive attributes and the output of the application machine learning model as inputs. The resultant choice of location for the new 5G tile should be generated in a manner that ensures demographic parity.

FIG. 4 depicts a high-level block diagram of a computing device or processing system specifically programmed to perform the functions described herein. As depicted in FIG. 4, the processing system 400 comprises one or more hardware processor elements 402 (e.g., a central processing unit (CPU), a microprocessor, or a multi-core processor), a memory 404 (e.g., random access memory (RAM) and/or read only memory (ROM)), a module 405 for minimizing algorithmic bias in machine learning models, and various input/output devices 406 (e.g., storage devices, including but not limited to, a tape drive, a floppy drive, a hard disk drive or a compact disk drive, a receiver, a transmitter, a speaker, a display, a speech synthesizer, an output port, an input port and a user input device (such as a keyboard, a keypad, a mouse, a microphone and the like)). Although only one processor element is shown, it should be noted that the computing device may employ a plurality of processor elements. Furthermore, although only one computing device is shown in the figure, if the method 300 as discussed above is implemented in a distributed or parallel manner for a particular illustrative example, i.e., the steps of the above method 300 or the entire method 300 is implemented across multiple or parallel computing devices, e.g., a processing system, then the computing device of this figure is intended to represent each of those multiple computing devices.

Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented. The hardware processor 402 can also be configured or programmed to cause other devices to perform one or more operations as discussed above. In other words, the hardware processor 402 may serve the function of a central controller directing other devices to perform the one or more operations as discussed above.

It should be noted that the present disclosure can be implemented in software and/or in a combination of software and hardware, e.g., using application specific integrated circuits (ASIC), a programmable gate array (PGA) including a Field PGA, or a state machine deployed on a hardware device, a computing device or any other hardware equivalents, e.g., computer readable instructions pertaining to the method discussed above can be used to configure a hardware processor to perform the steps, functions and/or operations of the above disclosed method 300. In one example, instructions and data for the present module or process 405 for minimizing algorithmic bias in machine learning models (e.g., a software program comprising computer-executable instructions) can be loaded into memory 404 and executed by hardware processor element 402 to implement the steps, functions, or operations as discussed above in connection with the illustrative method 300. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method can be perceived as a programmed processor or a specialized processor. As such, the present module 405 for minimizing algorithmic bias in machine learning models (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette, and the like. Furthermore, a “tangible” computer-readable storage device or medium comprises a physical device, a hardware device, or a device that is discernible by the touch. More specifically, the computer-readable storage device may comprise any physical devices that provide the ability to store information such as data and/or instructions to be accessed by a processor or a computing device such as a computer or an application server.

While various examples have been described above, it should be understood that the examples have been presented by way of illustration only, and not a limitation. Thus, the breadth and scope of any aspect of the present disclosure should not be limited by any of the above-described examples, but should be defined only in accordance with the following claims and their equivalents.

What is claimed is:

1. A method comprising:
generating, by a processing system including at least one processor and using a first machine learning model, a first output representing a prediction, where the first output is generated in response to a first plurality of inputs including sensitive features and non-sensitive features;
generating, by the processing system and using a second machine learning model, a second output that minimizes an influence of an algorithmic bias in the first output, where the second output is generated in response to a second plurality of inputs including the non-sensitive features and the first output; and
generating, by the processing system, a recommendation related to the prediction based on the second output.

2. The method of claim 1, wherein the prediction relates to a business decision.

3. The method of claim 1, wherein the sensitive features comprise data attributes that relate to an underrepresented entity or an underrepresented class, and the non-sensitive features are features which are independent of an underrepresented entity or an underrepresented class.

4. The method of claim 3, wherein at least one sensitive feature of the sensitive features has values which are non-binary.

5. The method of claim 1, wherein the algorithmic bias comprises a bias that is present in the first machine learning model.

6. The method of claim 1, wherein at least one of: the first machine learning model or the second machine learning model comprises a neural network.

7. The method of claim 6, wherein the second machine learning model is trained to produce the sensitive features as the second output based on the second plurality of inputs.

8. The method of claim 7, wherein the sensitive features are omitted from the second plurality of inputs.

9. The method of claim 8, wherein the sensitive features as produced as the second output are regressed.

10. The method of claim 9, wherein distributions of the sensitive features as produced as the second output are similar to distributions of the sensitive features as included in the first plurality of inputs.

11. The method of claim 6, wherein the first machine learning model minimizes a loss function of the first output, while the second machine learning model maximizes the loss function of the first output.

12. The method of claim 1, wherein the recommendation comprises a recommendation to accept the prediction.

13. The method of claim 1, wherein the recommendation comprises a recommendation to reject the prediction.

14. The method of claim 1, wherein the recommendation comprises a recommendation to repeat the generating the first output, the generating the second output, and the generating the recommendation.

15. The method of claim 14, wherein the repeating the generating the first output is performed using at least one of: a greater number of the sensitive features or a greater number of the non-sensitive features.

16. The method of claim 14, wherein the repeating the generating the first output is performed using at least one of: a different type of the sensitive features or a different type of the non-sensitive features.

17. The method of claim 1, wherein the recommendation comprises a recommendation to adjust at least one of: the generating the first output or the generating the second output.

18. The method of claim 1, wherein the adjusting comprises retraining at least one of: the first machine learning model or the second machine learning model.

19. A non-transitory computer-readable medium storing instructions which, when executed by a processing system including at least one processor, cause the processing system to perform operations, the operations comprising:
generating, using a first machine learning model, a first output representing a prediction, where the first output is generated in response to a first plurality of inputs including sensitive features and non-sensitive features;
generating, using a second machine learning model, a second output that minimizes an influence of an algorithmic bias in the first output, where the second output is generated in response to a second plurality of inputs including the non-sensitive features and the first output; and
generating a recommendation related to the prediction based on the second output.

20. A device comprising:
a processing system including at least one processor; and
a non-transitory computer-readable medium storing instructions which, when executed by the processing system, cause the processing system to perform operations, the operations comprising:
generating, using a first machine learning model, a first output representing a prediction, where the first output is generated in response to a first plurality of inputs including sensitive features and non-sensitive features;
generating, using a second machine learning model, a second output that minimizes an influence of an algorithmic bias in the first output, where the second output is generated in response to a second plurality of inputs including the non-sensitive features and the first output; and
generating a recommendation related to the prediction based on the second output.
